(19) United States
(12) Patent Application Publication
(10) Pub. No.: US 2026/0211475 A1
(43) Pub. Date: Jul. 23, 2026

(54) CONTROLLER POWER MANAGEMENT

(71) Applicant: Micron Technology, Inc., Boise, ID (US)

(72) Inventor: Leon Zlotnik, Camino, CA (US)

(21) Appl. No.: 19/451,872

(22) Filed: Jan. 16, 2026

Related U.S. Application Data
(60) Provisional application No. 63/748,259, filed on Jan. 22, 2025.

(51) Int. Cl. G06F 1/28

(52) U.S. Cl. CPC G06F 1/28

(57) ABSTRACT

A system and method for dynamic power management in computing devices such as memory devices. The system includes a controller and multiple memory dies connected via a power management bus. The controller dynamically claims and releases power tokens based on current and projected power needs, optimizing power distribution and improving performance. The method involves determining power requirements, claiming power tokens, and waiting for power tokens to be released by memory dies when the system exceeds its power budget. This approach ensures efficient power usage, reduces latency, and enhances overall system performance by preventing power allocation inefficiencies.

### PRIORITY APPLICATION

This application claims the benefit of priority to U.S. Provisional Application Ser. No. 63/748,259, filed Jan. 22, 2025, which is incorporated herein by reference in its entirety.

### TECHNICAL FIELD

Embodiments pertain to power management systems in computing devices and components of computing devices. Some further embodiments relate to power management systems in memory devices such as NAND flash memory devices.

### BACKGROUND

Power management in computing systems is important for many reasons. For example, for mobile and portable computing devices that run on batteries, effective power management directly affects how long these devices can operate between charges, which affects user productivity and device usability. For other computing devices such as personal devices all the way up to large data centers, reducing power consumption through effective management helps decrease energy usage, lowering both environmental impact and operating costs. This is particularly important as organizations face increasing pressure to reduce their carbon footprint and meet sustainability goals. In addition, excessive power usage leads to increased heat output, which can affect system reliability, performance, and component lifespan and necessitate additional cooling resources. Finally, exceeding power limitations can lead to system instability or failure. Effective power management ensures that available power is distributed appropriately to maintain stable operation while maximizing performance within the system's power constraints.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a logical diagram of a memory device according to some examples of the present disclosure.

FIG. 2 shows a memory device with a power management component according to some examples of the present disclosure.

FIG. 3 shows a timing diagram of a memory device with a four-channel memory bus according to some examples of the present disclosure.

FIG. 4 illustrates a computing system according to some examples of the present disclosure.

FIG. 5 illustrates an example computing environment including a memory system, in accordance with some examples of the present disclosure.

FIG. 6 shows a flowchart of a method of a controller participating in a power management scheme according to some examples of the present disclosure.

FIG. 7 illustrates a block diagram of an example machine upon which any one or more of the techniques (e.g., methodologies) discussed herein may be performed, according to some examples of the present disclosure.

### DETAILED DESCRIPTION

In computing systems, components often must share a fixed power budget to perform their operations. Traditional approaches often rely on static power allocation, where each component is assigned a fixed portion of the total system power budget based on worst-case scenarios. A power budget is the total amount of electrical power allocated to a system or device, which is distributed among its components to ensure stable operation and optimal performance within the system's power constraints. This static allocation creates inefficiencies because components are often reserved more power than they actually need under typical operating conditions. For example, a system controller might be allocated a power value that assumes maximum temperature and peak performance conditions, even though these conditions rarely occur in practice. This overly conservative approach means that other system components may be unnecessarily constrained, operating with less power than could actually be available to them, which results in degraded performance.

For example, in memory systems, this issue manifests when the memory controller is allocated power assuming worst-case conditions like maximum temperature and peak performance. In reality, the controller often operates at lower temperatures and doesn't require its full power allocation. This results in other devices in the memory system, such as the NAND dies themselves, being unnecessarily limited in their operations, even though additional power is actually available.

In some example systems, such as memory systems, certain components may allocate power using peak power management (PPM) which operates using a communication protocol where memory dies communicate over a shared power management bus. In some examples, the system may use a round-robin protocol where each PPM component takes turns communicating power needs and usage during defined time periods controlled by a common clock signal (ICLK). Each die, during its turn to communicate over the PPM bus, has the opportunity to claim a limited amount of the available power budget or release a previously claimed amount of the power budget. Each die also maintains information about the total power of all dies, enabling them to calculate available power budget.

Discrete units or portions of the power budget that are claimed from the PPM bus may be termed “power tokens.” Power tokens represent the ability to access and utilize a portion of the available power budget. Components thus claim power tokens by transmitting a claim in the form of an amount of power over the PPM bus. When a component holds a power token, it essentially has the right to use a certain amount of power from the shared budget. The allocation of power tokens ensures that power is distributed among the components in a controlled manner, preventing any single component from monopolizing the power resources. By dynamically managing the distribution of power tokens, the system can optimize power usage and improve overall performance.

The PPM protocol allows dies to release power tokens back to the available budget when operations complete. When power is released, other dies become aware of the newly available budget through the PPM bus. The next die in the sequence can then claim the released power tokens if needed for its operations.

For example, if there is a total budget of 1 amp shared across 8 nodes, each die can request power during its turn on the PPM budget. If the first die requests power tokens corresponding to 200 mA and the second requests 500 mA, they can claim that power since sufficient budget remains. However, if a third die needs more power than the remaining 300 mA budget, it must wait until other dies release their claimed power tokens.

In some examples, the controller and other components are not on the PPM bus and may have statically allocated power budgets. That is, the power for the NAND dies may be calculated as the remainder of the total budget of the device and the portion reserved for the controller and other fixed budgets. As noted, this can hinder performance when the controller does not need all of the static fixed budget.

In some examples, to make more efficient usage of the power budget of the memory device, a controller may be connected to a PPM bus and may claim and release power tokens corresponding to its current or projected power usage so that total system power may be better regulated and reductions in performance may be reduced. However, when the system controller requires more power than is currently available in the system power budget, the controller may have to wait until other components naturally complete their operations and release power back to the available budget. Moreover, it may be possible for another component to claim the released power tokens before the controller. This waiting period can significantly impact system performance and responsiveness, particularly when the controller needs to perform time-sensitive operations.

For example, in a system with a total power budget of 1 amp shared across multiple components, if the first component requests 200 mA and the second requests 500 mA, they can claim that power since sufficient budget remains. However, if the controller then needs more power than the remaining 300 mA budget, it must wait until other components complete their operations and release enough power tokens.

One solution for this problem is to assign multiple “instances” on the PPM bus to the controller. That is, the controller receives additional spots on the ring, and thus additional transmission token opportunities to claim power tokens from the PPM bus. This reduces the chances that power released by other components are taken before the controller can take them but does not eliminate the problem altogether. Even considering multiple instances, the controller must operate within the standard power management protocols, potentially leading to suboptimal system performance as it waits for power to become available through normal operation cycles.

Disclosed in some examples are methods, systems, devices (such as memory devices), and machine-readable mediums that enable a system controller to pre-reserve power by claiming power tokens that exceed the currently available power budget. While these power tokens are transmitted as consumed, the controller waits until other components release sufficient power tokens before performing its operations. In the meantime, other components are not able to claim these tokens prior to the controller. This approach ensures the controller will receive the needed power as soon as it becomes available, rather than having to compete with other components after power is released, while maintaining system stability by not actually consuming the power until it is properly released.

Furthermore, upon detecting that the controller claimed power tokens that placed the system over the power budget, the NAND dies are configured to release the tokens they hold at the earliest possibility. This earliest possibility may be at a first available exit point of the operation they are currently performing. In other examples, they may complete the current operation. In still other examples, the NAND dies may free up available power tokens by slowing down their operations by pausing one or more operations, completing fewer operations simultaneously, or slowing down a speed at which the operations are performed.

For example, a write operation that is very power consuming may not be uniform - that is, it goes over multiple pages and planes. Normally it proceeds until finished, but when forced to release tokens, the NAND die may pause after completing only a part of the operation. The NAND die then waits until power tokens are available again to finish the rest of the operation then. As another example, In many cases, there are multiple operations going on at the same time. For example, all operations together consume 200 power tokens. If the controller claims tokens that put the device 100 power tokens over the budget, a NAND die may release only 100 tokens rather than all 200. That is, it would finish some operations and some other operations can continue using the remaining 100 tokens.

When the controller has reserved too many power tokens, to prevent unfair distribution of power among system components, the controller may implement gradual power token release back to the power management bus. This approach prevents scenarios where the next component in sequence claims all released power, which could otherwise create unfair power distribution patterns.

These implementations can significantly improve system performance, particularly for power-limited operations. By removing overly pessimistic pre-reserved portions of the power budget and enabling more dynamic power allocation, the system can achieve up to 30-40% improvement in power-limited operations.

While the system is particularly beneficial for memory devices with multiple memory dies, the approach can be applied to any computing system where multiple components share a fixed power budget.

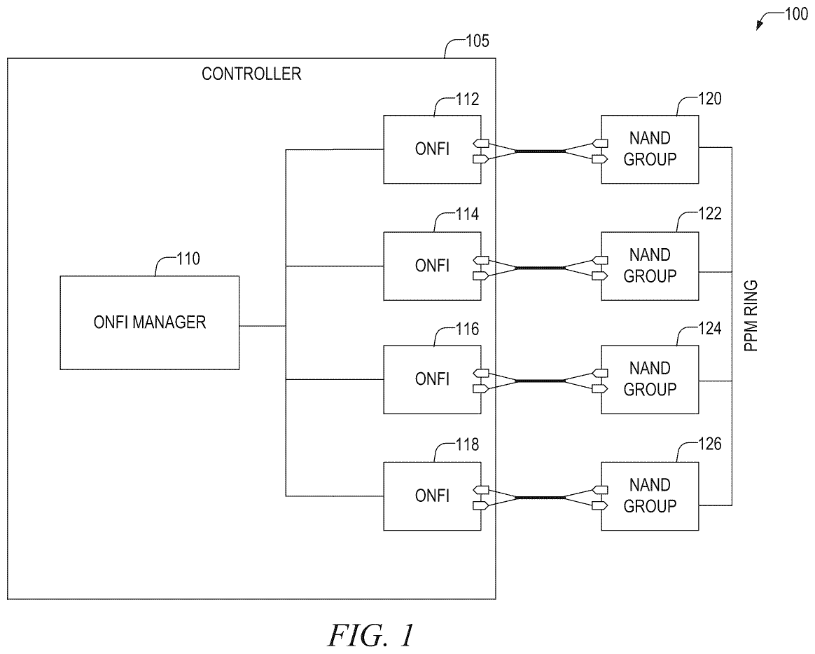

FIG. 1 shows a logical diagram of a memory device 100 according to some examples of the present disclosure. The memory device includes a controller 105 which communicates across an Open NAND Flash Interface (ONFI) to multiple NAND die groups 120-126. The controller 105 includes an ONFI Manager 110, which is responsible for managing the communication and control of multiple ONFI channels 112-118. The ONFI Manager 110 interfaces with four ONFI channels:
ONFI Channel 112, ONFI Channel 114, ONFI Channel 116, and ONFI Channel 118.

Each ONFI channel may be connected to a corresponding one or more NAND dies. Specifically, in FIG. 1, ONFI Channel 112 is connected to a NAND Die group 120, ONFI Channel 114 is connected to NAND Die group 122, ONFI Channel 116 is connected to NAND Die group 124, and ONFI Channel 118 is connected to NAND Die group 126. NAND die groups include one or more NAND dies. These connections facilitate the transfer of data and control signals between the ONFI Manager 110 and the NAND dies.

The memory device 100 also includes a PPM ring, which is a power management bus that allows the NAND dies to communicate and manage power allocation dynamically. The PPM ring ensures that power is distributed efficiently among the components, optimizing the performance and power consumption of the memory device 100.

The ONFI Manager 110 coordinates the operations of the ONFI channels and the NAND dies, ensuring that data transfers and power management are performed efficiently. The ONFI channels 112, 114, 116, and 118 handle the communication with the respective NAND dies within the NAND die groups 120, 122, 124, and 126, enabling the memory device 100 to perform read and write operations effectively. The ONFI Manager 110 is responsible for scheduling requests on the ONFI channels. The ONFI channels then carry out the transactions.

The memory device of FIG. 1 allocates power for the controller 105 according to a worst-case offset. That is, the power budget for the NAND dies is reduced by an amount of power that the controller would be expected to use in a worst case scenario. Given that the controller may not use this power, the NAND dies may be artificially limited.

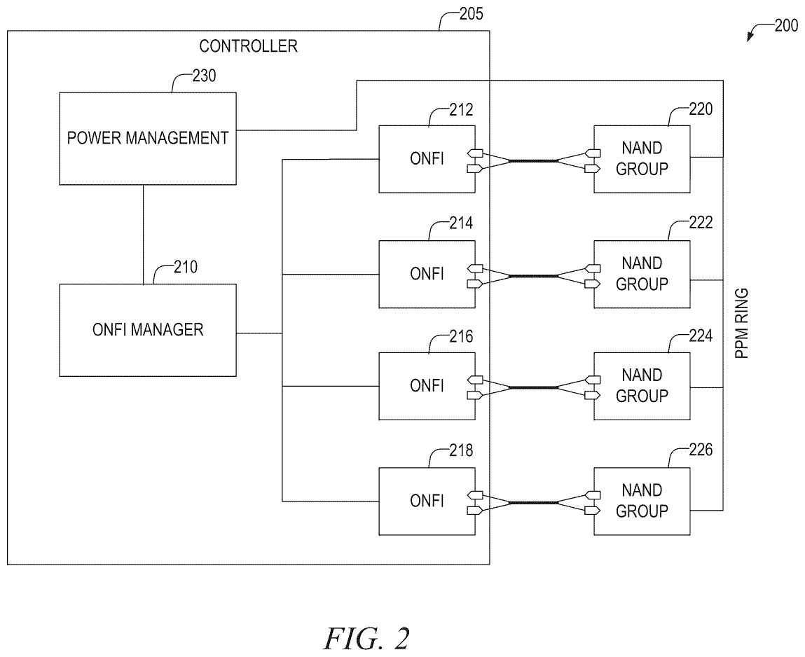

FIG. 2 shows a memory device 200 with a power management component 230 according to some examples of the present disclosure. The power management component 230 may communicate current or future power needs of the controller with the NAND dies over the PPM bus. The memory device 200 includes a controller 205 with an ONFI Manager 210, which is responsible for managing the communication and control of multiple ONFI channels. The ONFI Manager 210 interfaces with four ONFI channels: ONFI Channel 212, ONFI Channel 214, ONFI Channel 216, and ONFI Channel 218. Each ONFI channel may be connected to corresponding one or more NAND dies. Specifically, ONFI Channel 212 is connected to NAND Die group 220, ONFI Channel 214 is connected to NAND Die group 222, ONFI Channel 216 is connected to NAND Die group 224, and ONFI Channel 218 is connected to NAND Die group 226. NAND die groups may include one or more NAND dies. These connections facilitate the transfer of data and control signals between the ONFI Manager 210 and the NAND dies.

As noted, the memory device 200 also includes a Power Management Component 230. The Power Management Component 230 interfaces with the ONFI Manager 210 to identify current or future power needs of the controller 205 to claim or release power tokens on the PPM ring.

The ONFI Manager 210 coordinates the operations of the ONFI channels and the NAND dies, ensuring that data transfers and power management are performed efficiently. The ONFI channels 212, 214, 216, and 218 handle the communication with the respective NAND die groups 220, 222, 224, and 226, enabling the memory device 200 to perform read and write operations effectively.

As previously noted, the power management component 230 may claim power tokens for predicted or current power needs of the controller 205 whether or not the tokens put the device over the power limit. The power management component 230 may also communicate with the ONFI manager 210 to schedule and release transfers across the ONFI bus based upon the total power usage of the device. For example, by holding transactions which would violate the power limits until other components (e.g., the NAND dies) have released enough tokens.

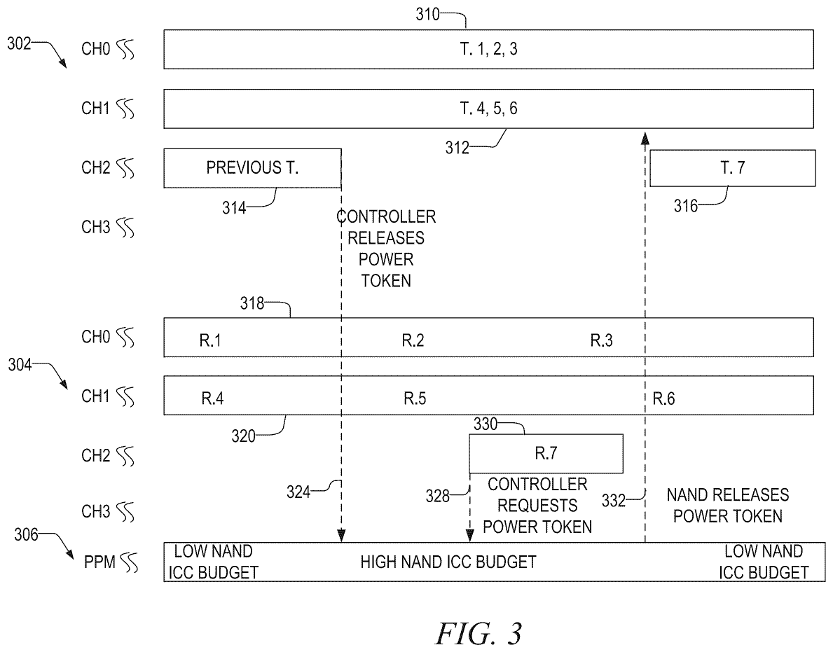

FIG. 3 shows a timing diagram of a memory device with a four-channel ONFI memory bus according to some examples of the present disclosure. The diagram illustrates the sequence of ONFI transactions 302 and ONFI requests 304, as well as the interaction with the PPM bus 306.

In the example of FIG. 3, only three channels are permitted to be active due to power constraints. Requests are requests from the ONFI manager to the ONFI channel to begin a transaction. Transactions are the actual transactions between the ONFI channel and the die. ONFI manager has sent Channel 0 ONFI requests 318 (requests 1, 2, and 3) and the ONFI channel has begun the corresponding transactions 310 (1, 2, and 3). Similarly, ONFI manager has sent Channel 1 requests 320 (4, 5, and 6) and it has begun corresponding transactions 310 (4, 5, and 6). Initially channel 2 has a previous transaction 314 that is being completed. Channel 3 (CH3) is shown without any transactions in this segment of the timing diagram as there is no power budget available.

Once the previous transaction 314 completes, the controller does not need as much power, and so it releases additional power tokens at 324 that may be used by the NAND dies. At 330 a new request, request 7 is scheduled by the ONFI manager and so the controller claims additional power tokens 328. The corresponding transaction is not performed yet, as the NAND dies still hold the power tokens released at operation 324. At operation 332, a NAND device releases enough power tokens to complete transaction 7 316. The controller then causes transaction 7 316 to be performed.

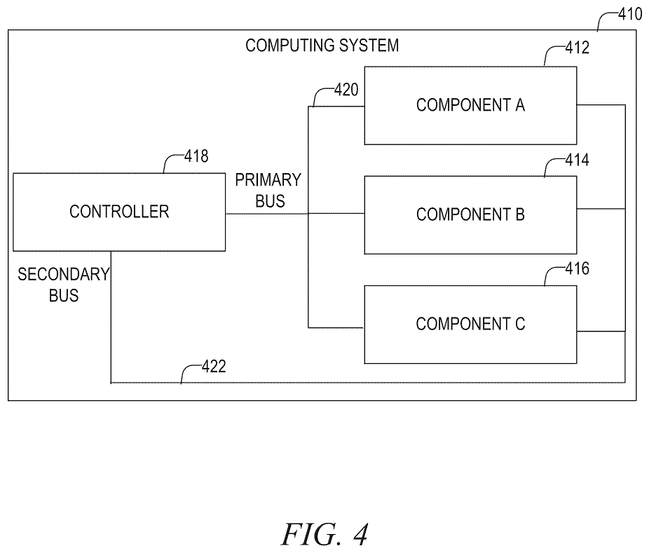

While the present disclosure has described the inventive techniques disclosed herein in the context of memory systems, a person of ordinary skill in the art will appreciate that these inventive techniques may be utilized with other systems as well. FIG. 4 illustrates a computing system 410 with three components: component A 412, component B 414, and component C 416. The three components are connected to a controller 418. The controller configures, receives status information from, and/or manages the components.

The primary bus 420 is a communication bus used primarily by the controller 418 to communicate data and operations with the components. For example, if the components are memory devices, the primary bus 420 may be used to communicate data stored in the memory devices. The controller may use a secondary bus 422, which is also a communication bus, to communicate one or more of status information, management commands, configuration commands, power management commands, or the like. In some examples, the controller 418, component A 412, component B 414, and component C 416 may claim and release power tokens from the secondary bus 422. In some examples, the controller 418 may claim power tokens in excess of the power budget of the computing system 410. The controller 418 may wait until other components have released power tokens such that the system is below or equal to the power budget before using those tokens to perform operations.

Controller, component A 412, component B 414, and/or component C 416 may be software components or hardware components (e.g., logic circuits such as an Application Specific Integrated Circuit (ASIC)). In some examples, the controller, component A 412, component B 414, and/or component C 416 may be on a same device. In other examples, one or more of the components and the controller 418 may be, or be located on, different devices. In some examples, the communication buses (e.g., either or both of primary bus 420 and secondary bus 422) may be local busses such as Peripheral Component Interconnect (PCI), Universal Serial Bus, memory busses, token ring busses, ethernet busses, and the like. In other examples, the buses may be remote busses such as those facilitating communication between devices. For example, a CXL bus.

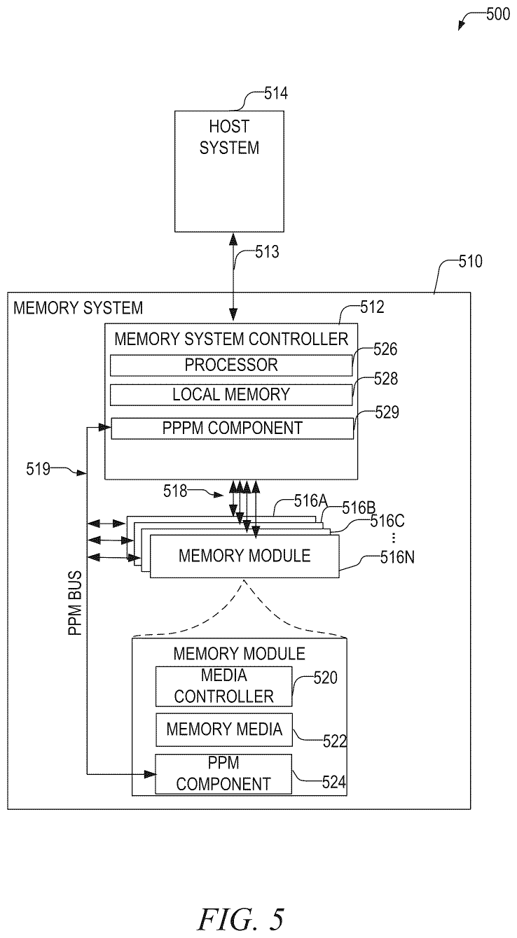

FIG. 5 illustrates an example computing environment 500 including a memory system 510, in accordance with some examples of the present disclosure. In some examples, the memory system 510 can be volatile storage such as Random Access Memory (RAM), cache memory, dynamic RAM (DRAM), synchronous DRAM (SDRAM), double data rate SDRAM (DDR), static RAM (SRAM), Graphics DDR (GDDR), or the like. In some examples, the memory system 510 can be non-volatile storage such as a Not-AND (NAND) flash, NOR flash, magnetic storage (e.g., a hard-disk drive), tape storage, or the like. In some examples, the memory system 510 can include both volatile and non-volatile storage, by utilizing, for example, memory modules 516A-N containing different types of memory media 522 or by utilizing one or more single memory modules that include both volatile and non-volatile memory media 522. The memory system 510 may be an error-correcting memory system in that at least some of the memory media 522 includes error correcting memory.

In an example, the memory system 510 can be a discrete memory and/or storage device component of a host system. In other examples, the memory system 510 can be a portion of an integrated circuit (e.g., system on a chip (SOC), etc.), stacked or otherwise included with one or more other components of a host system. In some examples, the memory system 510 may be part of a distributed memory system with multiple memory systems 510 and multiple host systems that may each include one or more processors. For example, a distributed memory system may operate according to a Compute Express Link (CXL) framework, such as a CXL. mem framework. The memory system may also have compute capabilities to support compute-near-memory functionalities-e.g., by using the processor 526 of memory system controller 512, media controller 520, or some other processor that is not shown.

As noted, the host 514, as well as memory system 510 can be integrated into a single host computing system. The host system can be in the form of a desktop computer, laptop computer, network server, mobile device, or such computing device that includes a memory and a processing device. The host system and/or the memory system 510 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the host 514 and to the memory system 510 so that the host system can read data from or write data to the memory system 510. As used herein, “coupled to” generally refers to a connection between components, which can be an indirect communicative connection or direct communicative connection (e.g., without intervening components), whether wired or wireless, including connections such as, electrical, optical, magnetic, and the like.

The memory system 510 is configured with a memory system controller 512 that interfaces with the host 514. The host 514 may include a hardware processor, which may be a multi-core hardware processor, and communicates with the memory system controller 512 via a memory controller interface 513. Through this interface, the host 514 can issue commands to the memory system controller 512, such as a request to store data, which is accompanied by the data itself and potentially the target memory address for storage. In response, the memory system controller 512 can acknowledge the command and execute the data storage operation, providing confirmation back to the host 514 through the memory controller interface 513. Similarly, the host 514 can send a command to retrieve data, specifying the memory address from which to load the data. Upon receiving such a command, the memory system controller 512 retrieves the requested data and delivers it to the host 514 through the memory controller interface 513.

In certain embodiments, the host 514 and the memory system controller 512 are integrated onto a single die or different dies, but within a unified package. For example, in systems based on the x86 architecture, the memory system controller 512 is typically on the same die as the processor cores of host 514, thereby streamlining the memory access operations. Alternatively, there are configurations where the memory system controller 512 is situated on a distinct die, separate from that of the host 514 but within the same CPU package, allowing for modular design and potential customization of the memory system. In yet other examples, the memory system controller 512 may not be on the same die or package as the host 514.

The host 514 may communicate with the memory system controller 512 through a memory controller interface 513 and the memory system controller 512 may communicate with one or more memory modules 516A-516N upon which the physical memory is located through the memory module interface 518. In examples in which the memory system controller 512 is not on the same die or package as the host 514, the memory controller interface 513 may be the system bus, front-side bus, or other interface and the memory module interface 518 may be an internal bus of the memory system 510, such as internal pins or traces or some other interface such as an ONFI bus. In other examples, where the memory system controller 512 is on a same die or package as the host 514, the memory controller interface 513 may be one or more traces, pins, or some other interface and the memory module interface 518 may be a system bus.

The memory controller interface 513 and/or the memory module interface 518 may, depending on the design of the system, operate as one or more traces or pins, a Peripheral Component Interconnect-Express (PCIe) interface, a UFS interface, a serial advanced technology attachment (SATA) interface, a universal serial bus (USB) interface, an ONFI interface, a Fibre Channel interface, Serial Attached SCSI (SAS) interface, memory fabric, an eMMC interface, or the like.

The memory modules, designated as 516A through 516N, are capable of incorporating a diverse array of memory media 522, which may be either volatile or non-volatile in nature. The memory media 522 is comprised of elements such as memory cells, magnetic sectors, or equivalent data storage units. These memory modules can manifest in various configurations, including but not limited to Single Inline Memory Modules (SIMMs), Dual Inline Memory Modules (DIMMs), Solid State Drives (SSDs), embedded MultiMediaCards (eMMCs), Hard Disk Drives (HDDs), tape drives, among others. The memory media 522 within modules 516A-516N may encompass Random Access Memory (RAM), Static RAM (SRAM), Dynamic RAM (DRAM), Synchronous DRAM (SDRAM), NAND flash memory, magnetic media, phase-change memory (PCM), magneto-resistive random access memory (MRAM), NOR flash memory, electrically erasable programmable read-only memory (EEPROM), cross-point memory, and similar technologies. For instances where the memory media 522 consists of NAND-type memory, the configuration may involve a range of cell architectures, from single-level cells (SLCs) to multi-level cells (MLCs). MLCs may include triple-level cells (TLCs), quad-level cells (QLCs), and the like.

In some examples, the data storage units of the memory media 522 (such as memory cells) may be organized into one or more logical structures. For volatile storage, one example of a logical organization groups memory cells by ranks, banks, rows, and columns. For non-volatile storage, one example logical organization includes grouping cells into planes, sub-blocks, blocks, and/or pages. Other logical organizations may include sectors, tracks, cylinders, clusters, and so on.

In some examples, one or more of the memory modules 516A-516N may include a media controller 520 that may handle tasks such as accessing data from the memory media, writing data to the memory media, refreshing memory cells and communications over the memory module interface with the memory system controller 512. For example, the media controller 520 can parse a command and determine the affected memory cells from the memory media 522 and can read and/or write a desired value to those memory cells. Media controller 520 can be responsible for refreshing or otherwise maintaining the data stored in the memory media 522. In some examples, the media controller 520 may handle one or more of the functions traditionally associated with the memory system controller 512. In some examples, the memory modules 516A-N do not include a media controller 520.

The media controller 520 can include hardware such as one or more integrated circuits and/or discrete components, a buffer memory, or a combination thereof. The media controller 520 can be a microcontroller, special purpose logic circuitry (e.g., a field programmable gate array (FPGA), an application specific integrated circuit (ASIC), etc.), or other suitable processor(s). The media controller 520 can include a processor (processing device) configured to execute instructions stored in a local memory. Media controller 520 can also include address circuitry, row decoders, I/O circuitry write circuitry, column decoders, sensing circuitry, and other latches for decoding addresses, writing to, and reading from the memory media 522.

The local memory of the media controller 520 can include embedded memory configured to store instructions for performing various processes, operations, logic flows, and routines that control the memory media 522, including handling communications between the memory module 516A-516N and the memory system controller 512. In some embodiments, the local memory of the media controller 520 can include memory registers storing, e.g., memory pointers, fetched data, etc. The local memory can also include read-only memory (ROM) for storing micro-code.

The memory system controller 512 (controller) can include a processor 526 configured to execute instructions stored in a local memory 528. The processor 526 can be a microcontroller, special purpose logic circuitry (e.g., a field programmable gate array (FPGA), an application specific integrated circuit (controller), etc.), general purpose processor configured by software (e.g., firmware), or other suitable processor. In the illustrated example, the local memory 528 may store instructions for performing various processes, operations, logic flows, and routines that control operation of the memory system 510, including handling communications between the memory system 510 and the host 514 and communications between the memory system controller 512 and the memory modules 516A-516N. In some embodiments, the local memory 528 of the memory system controller 512 can include memory registers storing, e.g., memory pointers, fetched data, etc. The local memory can also include read-only memory (ROM) for storing micro-code.

Local memory 528 may also include various management tables such as translation tables translating logical addresses used by the host 514 into physical memory addresses that define a physical location of the memory cells. In other examples, the management tables can instead or additionally include information regarding block age, block erase count, error history, or one or more error counts (e.g., a write operation error count, a read bit error count, a read operation error count, an erase error count, etc.) for one or more blocks of memory cells coupled to the memory system controller 512.

As noted, the memory system controller 512 can receive commands or operations (memory access commands) from the host 514 (or other component of a host) and can convert the commands or operations into instructions or appropriate commands to achieve the desired access to the memory modules 516A to 516N. The memory system controller 512 can be responsible for other operations such as wear leveling operations (e.g., garbage collection operations, reclamation), error detection and error-correcting code (ECC) operations, refresh operations, encryption operations, caching operations, block retirement, and address translations between a logical block address and a physical block address that are associated with the memory modules 516A to 516N. The memory system controller 512 can further include interface circuitry to communicate with the processor via the memory controller interface 513. The interface circuitry can convert the commands received from the host 514 into command instructions to access the memory modules 516A to 516N over the memory module interface 518 as well as convert responses associated with the memory modules 516A to 516N into information for the host 514 or other component of the host system.

The memory system controller 512 may include or be coupled to a PPM component 529 for participating in the power management scheme with the one or more memory modules 516A-516N over the PPM bus 519. The PPM component 529 may monitor controller power needs (either current or predicted future needs), as well as temperature and other operational metrics of the memory system 510 and adjust the controller power draw by claiming or releasing tokens on the PPM bus 519. As noted, the PPM component 529 may claim power tokens in excess of the power budget of memory system 510. In these examples, the memory system controller 512 may wait until one or more memory modules release enough power tokens that the performance of the operations for which the power tokens were claimed would not put the memory system 510 over the power budget.

In some examples, each memory module 516 may have a PPM component 524. In some examples, each memory module 516 may have multiple dies which may each have a PPM component 524. In some examples, instead of a discrete controller, the functionality of the PPM component 529 may be implemented by a component - e.g., a hardware or software component. PPM component 524 determines current or predicted future power needs of the memory module and claims and releases power tokens on the PPM bus 519 in accordance with these needs.

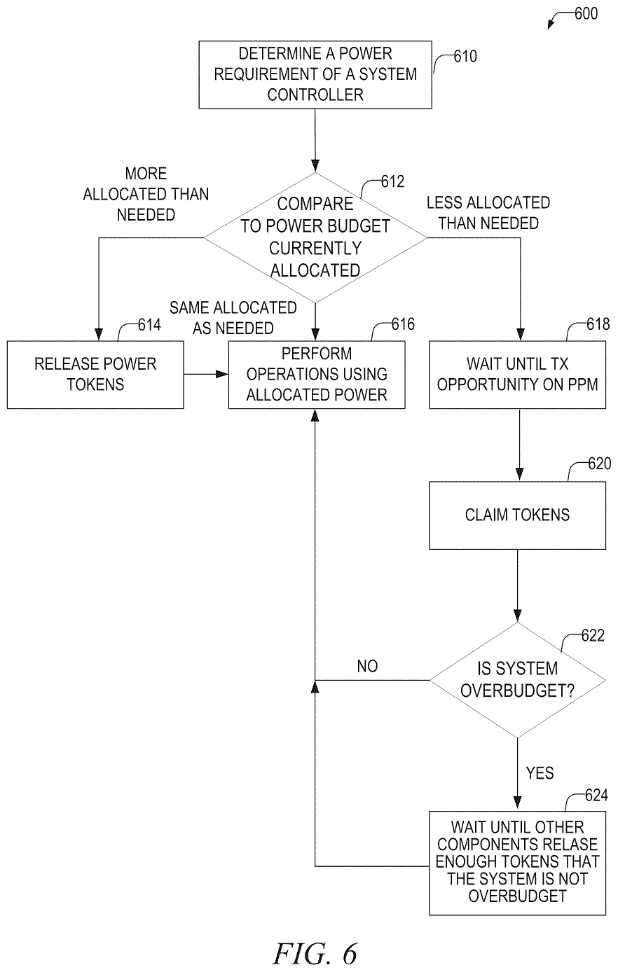

FIG. 6 shows a flowchart of a method 600 of a controller participating in a power management scheme according to some examples of the present disclosure. At operation 610, the method begins with determining a power requirement of a system controller. This involves assessing the current or projected power needs of the controller based on various factors such as queued or pending transactions, ongoing operations, temperature, and other relevant metrics.

At operation 612, the method compares the determined power requirement to the power budget currently allocated to the system controller. This comparison helps to identify whether the allocated power is more, less, or the same as the required power. If the comparison reveals that more power is allocated than needed, the method proceeds to operation 614, where the system controller releases the excess power budget to other components over the PPM bus. In some examples, this power release may be gradual, releasing some power tokens over time to avoid a single component claiming all the power tokens. Flow then proceeds to operation 616 where the operations are performed using the allocated power.

If the comparison indicates that the allocated power is the same as the needed power, the method moves to operation 616, where the system controller performs operations using the allocated power. If the comparison shows that less power is allocated than needed, the method advances to operation 618, where the system controller waits until a transmission (TX) opportunity on the power management bus (PPM) arises. This may be a transmission power of a next instance of the controller in examples where the controller has multiple instances (and thus multiple transmission opportunities on the PPM bus). At operation 620, once the control has the transmission opportunity on the PPM bus, the system controller claims the necessary power tokens from the PPM bus. These tokens represent the additional power required to meet the controller's needs. In some examples, the tokens may be claimed regardless of the total budget of the system.

Following the token claim, the method checks at operation 622 whether the system is overbudget. This involves verifying if the total power consumption, including the newly acquired tokens, exceeds the system's power budget. If the system is overbudget, the method proceeds to operation 624, where the system controller waits until other components release enough tokens to bring the system back within the power budget. This ensures that the controller does not perform operations that would exceed the available power, maintaining system stability.

Once the system is no longer overbudget, the method returns to operation 616, where the system controller performs operations using the allocated power, including the newly acquired tokens. This iterative process ensures that the controller dynamically adjusts the power consumption based on real-time needs and available resources.

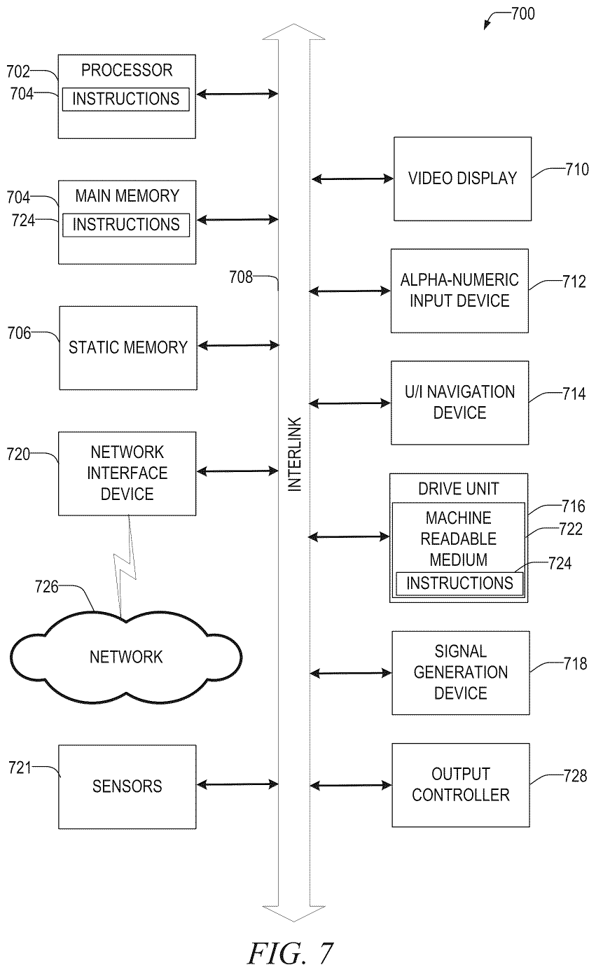

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be in the form of a memory device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 700 may implement one or more or all of the components of the memory device 100, 200, the timing diagrams of FIG. 3, the system of FIG. 4, the memory system of FIG. 5, the method of FIG. 6.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 700 may include one or more hardware processors, such as processor 702. Processor 702 may be a central processing unit (CPU), a graphics processing unit (GPU), a hardware processor core, or any combination thereof. Machine 700 may include a main memory 704 and a static memory 706, some or all of which may communicate with each other via an interlink (e.g., bus) 708. Examples of main memory 704 may include Synchronous Dynamic Random-Access Memory (SDRAM), such as Double Data Rate memory, such as DDR4 or DDR5. Interlink 708 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720. The Machine 700 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

### Other Notes and Examples

Example 1 is a memory device, the memory device comprising: a plurality of memory dies communicatively coupled through a power management bus, each of the plurality of memory dies reserving power from an allocated power of the memory device prior to performing memory operations that utilize power by Exampleing portions of power over the power management bus; a system controller, the system controller communicatively coupled to the plurality of memory dies over the power management bus, the system controller executing instructions, which when executed by the system controller, cause the system controller to perform operations comprising: determining that a power requirement of the system controller exceeds a current power allocation of the system controller; responsive to determining that the power requirement of the system controller exceeds the current power allocation of the system controller, claiming portions of power equal to a difference between the current power allocation of the system controller and the power requirement of the system controller, the portions of power claimed over the power management bus; and determining that a total amount of power reserved by the memory device exceeds the allocated power of the memory device, and in response, waiting to perform a scheduled operation until after an amount power is released by one or more of the plurality of memory dies that reduces the total amount of power reserved by the memory device to an amount that no longer exceeds the allocated power, the plurality of memory dies not claiming the released power of the one or more of the plurality of memory dies due to the portions of power claimed over the power management bus by the system controller.

In Example 2, the subject matter of Example 1 includes, wherein one of the plurality of memory dies is configured to detect that the controller has Exampleed portions of power exceeding a total system power and in response, pause a currently executing operation and release portions of power the one of the plurality of memory dies holds.

In Example 3, the subject matter of Examples 1-2 includes, wherein one of the plurality of memory dies is configured to detect that the controller has Exampleed portions of power exceeding a total system power and in response, reduce a number of operations being performed and release portions of power the one of the plurality of memory dies holds.

In Example 4, the subject matter of Examples 1-3 includes, wherein the system controller determines the power requirement based on at least one of: temperature, or scheduled operations.

In Example 5, the subject matter of Examples 1-4 includes, wherein the system controller is configured to request additional portions of power in response to detecting an increase in temperature.

In Example 6, the subject matter of Examples 1-5 includes, wherein the system controller is configured to gradually release portions of power back to the power management bus to prevent unfair distribution among the plurality of memory dies.

In Example 7, the subject matter of Examples 1-6 includes, wherein Exampleing portions of power occur during a transmission opportunity of the system controller on the power management bus.

Example 8 is a method for managing power in a memory device, the method comprising: using one or more computer processors of the memory device: determining that a power requirement of a system controller exceeds a current power allocation of the system controller; responsive to determining that the power requirement of the system controller exceeds the current power allocation of the system controller, Exampleing portions of power equal to a difference between the current power allocation of the system controller and the power requirement of the system controller, the portions of power claimed over a power management bus; and determining that a total amount of power reserved by the memory device exceeds the allocated power of the memory device, and in response, waiting to perform a scheduled operation until after an amount power is released by one or more of the plurality of memory dies that reduces the total amount of power reserved by the memory device to an amount that no longer exceeds the allocated power, the plurality of memory dies not claiming the released power of the one or more of the plurality of memory dies due to the portions of power claimed over the power management bus by the system controller.

In Example 9, the subject matter of Example 8 includes, wherein one of the plurality of memory dies is configured to detect that the controller has Exampleed portions of power exceeding a total system power and in response, pause a currently executing operation and release portions of power the one of the plurality of memory dies holds.

In Example 10, the subject matter of Examples 8-9 includes, wherein one of the plurality of memory dies is configured to detect that the controller has Exampleed portions of power exceeding a total system power and in response, reduce a number of operations being performed and release portions of power the one of the plurality of memory dies holds.

In Example 11, the subject matter of Examples 8-10 includes, wherein determining the power requirement further comprises assessing at least one of: temperature, or scheduled operations.

In Example 12, the subject matter of Examples 8-11 includes, wherein the method further comprises requesting additional portions of power in response to detecting an increase in temperature.

In Example 13, the subject matter of Examples 8-12 includes, wherein the method further comprises gradually releasing portions of power back to the power management bus to prevent unfair distribution among the plurality of memory dies.

In Example 14, the subject matter of Examples 8-13 includes, wherein Exampleing portions of power occurs during a transmission opportunity of the system controller on the power management bus.

Example 15 is a non-transitory machine-readable medium, storing instructions for managing power in a memory device, the instructions, which when executed, cause a machine to perform operations comprising: determining that a power requirement of a system controller exceeds a current power allocation of the system controller; responsive to determining that the power requirement of the system controller exceeds the current power allocation of the system controller, Exampleing portions of power equal to a difference between the current power allocation of the system controller and the power requirement of the system controller, the portions of power claimed over a power management bus; and determining that a total amount of power reserved by the memory device exceeds the allocated power of the memory device, and in response, waiting to perform a scheduled operation until after an amount power is released by one or more of the plurality of memory dies that reduces the total amount of power reserved by the memory device to an amount that no longer exceeds the allocated power, the plurality of memory dies not claiming the released power of the one or more of the plurality of memory dies due to the portions of power claimed over the power management bus by the system controller.

In Example 16, the subject matter of Example 15 includes, wherein one of the plurality of memory dies is configured to detect that the controller has Exampleed portions of power exceeding a total system power and in response, pause a currently executing operation and release portions of power the one of the plurality of memory dies holds.

In Example 17, the subject matter of Examples 15-16 includes, wherein one of the plurality of memory dies is configured to detect that the controller has Exampleed portions of power exceeding a total system power and in response, reduce a number of operations being performed and release portions of power the one of the plurality of memory dies holds.

In Example 18, the subject matter of Examples 15-17 includes, wherein the operation of determining the power requirement further comprises assessing at least one of: temperature, or scheduled operations.

In Example 19, the subject matter of Examples 15-18 includes, wherein the operations further comprise requesting additional portions of power in response to detecting an increase in temperature.

In Example 20, the subject matter of Examples 15-19 includes, wherein the operations further comprise gradually releasing portions of power back to the power management bus to prevent unfair distribution among the plurality of memory dies.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A memory device, the memory device comprising:
a plurality of memory dies communicatively coupled through a power management bus, each of the plurality of memory dies reserving power from an allocated power of the memory device prior to performing memory operations that utilize power by claiming portions of power over the power management bus;
a system controller, the system controller communicatively coupled to the plurality of memory dies over the power management bus, the system controller executing instructions, which when executed by the system controller, cause the system controller to perform operations comprising:
determining that a power requirement of the system controller exceeds a current power allocation of the system controller;
responsive to determining that the power requirement of the system controller exceeds the current power allocation of the system controller, claiming portions of power equal to a difference between the current power allocation of the system controller and the power requirement of the system controller, the portions of power claimed over the power management bus; and
determining that a total amount of power reserved by the memory device exceeds the allocated power of the memory device, and in response, waiting to perform a scheduled operation until after an amount power is released by one or more of the plurality of memory dies that reduces the total amount of power reserved by the memory device to an amount that no longer exceeds the allocated power, the plurality of memory dies not claiming the released power of the one or more of the plurality of memory dies due to the portions of power claimed over the power management bus by the system controller.

2. The memory device of claim 1, wherein one of the plurality of memory dies is configured to detect that the controller has claimed portions of power exceeding a total system power and in response, pause a currently executing operation and release portions of power the one of the plurality of memory dies holds.

3. The memory device of claim 1, wherein one of the plurality of memory dies is configured to detect that the controller has claimed portions of power exceeding a total system power and in response, reduce a number of operations being performed and release portions of power the one of the plurality of memory dies holds.

4. The memory device of claim 1, wherein the system controller determines the power requirement based on at least one of: temperature, or scheduled operations.

5. The memory device of claim 1, wherein the system controller is configured to request additional portions of power in response to detecting an increase in temperature.

6. The memory device of claim 1, wherein the system controller is configured to gradually release portions of power back to the power management bus to prevent unfair distribution among the plurality of memory dies.

7. The memory device of claim 1, wherein claiming portions of power occur during a transmission opportunity of the system controller on the power management bus.

8. A method for managing power in a memory device, the method comprising:
using one or more computer processors of the memory device:
determining that a power requirement of a system controller exceeds a current power allocation of the system controller;
responsive to determining that the power requirement of the system controller exceeds the current power allocation of the system controller, claiming portions of power equal to a difference between the current power allocation of the system controller and the power requirement of the system controller, the portions of power claimed over a power management bus; and
determining that a total amount of power reserved by the memory device exceeds the allocated power of the memory device, and in response, waiting to perform a scheduled operation until after an amount power is released by one or more of the plurality of memory dies that reduces the total amount of power reserved by the memory device to an amount that no longer exceeds the allocated power, the plurality of memory dies not claiming the released power of the one or more of the plurality of memory dies due to the portions of power claimed over the power management bus by the system controller.

9. The method of claim 8, wherein one of the plurality of memory dies is configured to detect that the controller has claimed portions of power exceeding a total system power and in response, pause a currently executing operation and release portions of power the one of the plurality of memory dies holds.

10. The method of claim 8, wherein one of the plurality of memory dies is configured to detect that the controller has claimed portions of power exceeding a total system power and in response, reduce a number of operations being performed and release portions of power the one of the plurality of memory dies holds.

11. The method of claim 8, wherein determining the power requirement further comprises assessing at least one of: temperature, or scheduled operations.

12. The method of claim 8, wherein the method further comprises requesting additional portions of power in response to detecting an increase in temperature.

13. The method of claim 8, wherein the method further comprises gradually releasing portions of power back to the power management bus to prevent unfair distribution among the plurality of memory dies.

14. The method of claim 8, wherein claiming portions of power occurs during a transmission opportunity of the system controller on the power management bus.

15. A non-transitory machine-readable medium, storing instructions for managing power in a memory device, the instructions, which when executed, cause a machine to perform operations comprising:
determining that a power requirement of a system controller exceeds a current power allocation of the system controller;
responsive to determining that the power requirement of the system controller exceeds the current power allocation of the system controller, claiming portions of power equal to a difference between the current power allocation of the system controller and the power requirement of the system controller, the portions of power claimed over a power management bus; and
determining that a total amount of power reserved by the memory device exceeds the allocated power of the memory device, and in response, waiting to perform a scheduled operation until after an amount power is released by one or more of the plurality of memory dies that reduces the total amount of power reserved by the memory device to an amount that no longer exceeds the allocated power, the plurality of memory dies not claiming the released power of the one or more of the plurality of memory dies due to the portions of power claimed over the power management bus by the system controller.

16. The non-transitory machine-readable medium of claim 15, wherein one of the plurality of memory dies is configured to detect that the controller has claimed portions of power exceeding a total system power and in response, pause a currently executing operation and release portions of power the one of the plurality of memory dies holds.

17. The non-transitory machine-readable medium of claim 15, wherein one of the plurality of memory dies is configured to detect that the controller has claimed portions of power exceeding a total system power and in response, reduce a number of operations being performed and release portions of power the one of the plurality of memory dies holds.

18. The non-transitory machine-readable medium of claim 15, wherein the operation of determining the power requirement further comprises assessing at least one of: temperature, or scheduled operations.

19. The non-transitory machine-readable medium of claim 15, wherein the operations further comprise requesting additional portions of power in response to detecting an increase in temperature.

20. The non-transitory machine-readable medium of claim 15, wherein the operations further comprise gradually releasing portions of power back to the power management bus to prevent unfair distribution among the plurality of memory dies.
